(19) United States
(12) Patent Application Publication
(10) Pub. No.: US 2007/0086820 A1
(43) Pub. Date: Apr. 19, 2007

(54) System and method for indicating position of a moveable mechanism

(76) Inventors: Steven M. Goss, Corvallis, OR (US); Gregory F. Carlson, Corvallis, OR (US); Ronald G. Paul, Vancouver, WA (US); Todd A. McClelland, Corvallis, OR (US); Randall L. Stockberger, Independence, OR (US)

Correspondence Address: BRINKS HOFER GILSON & LIONE/MARVELL, P.O. BOX 10395, CHICAGO, IL, 60610, US

(21) Appl. No.: 11/253,092

(22) Filed: Oct. 18, 2005

(51) Int. Cl. B41J 29/38

(52) U.S. Cl. 400/76

(57) ABSTRACT

A method and apparatus are disclosed for using a drive belt as a position encoder. A position control apparatus includes a belt coupled to a mechanism, where the belt contains a machine-readable position indication and is operable to convey the mechanism. A position control method includes reading a position indication from a belt that is operable to convey a mechanism, and using the position indication to determine a position of the mechanism.

### DESCRIPTION OF RELATED ART

Position control systems are typically used to determine the location of mobile mechanisms and to control their movement. These systems can be implemented in a great variety of devices, including, for example, ink-jet printers (e.g., for controlling the position of the print head).

Ink-jet printers work by using an array of nozzles located in a print head to spray drops of ink directly on paper. Once the paper is fed into the printer, a print head electric motor (e.g., a stepper or DC motor) moves a drive belt thereby moving the print head assembly coupled to such drive belt across the page. The motor may briefly pause each time that the print head sprays dots of ink on the page, where colors (e.g., a combination of CMYK colors) are delivered in very precise amounts. At the end of each complete pass, the paper advances. Depending on the printer design, the print head is reset to the beginning side of the page or, in most cases, simply reverses direction and begins to move back across the page as it prints. Consequently, control of the print head location is of primary importance for its proper operation. Furthermore, the print head must move at very steady and specific speeds so that ink drops are spaced at equal intervals, otherwise certain parts of the image become compressed whereas others are expanded, thereby generating image artifacts.

Position control systems use feedback to control a mobile mechanism. For instance, in the ink-jet printer example described above, the print head (a mobile mechanism) is attached to a belt which is responsible for conveying it across the page. A location indication is obtained from a separate and independently assembled optical encoding strip positioned in a direction parallel to the belt. A microprocessor uses this position indication to drive the belt and thus control the position and movement of the print head.

### BRIEF SUMMARY OF THE INVENTION

Embodiments of the invention relate to a method and apparatus for a position control system. In one embodiment, a position control apparatus includes a belt coupled to a mechanism, where the belt contains a machine-readable position indication and is operable to convey the mechanism (e.g., print head). In another embodiment, a position control method includes reading a position indication from a belt operable to convey a mechanism and using the position indication to determine a position of the mechanism. The terms “belt,” “conveyor belt,” and “drive belt” are used interchangeably herein.

Certain embodiments of the invention provide a general-purpose, low-cost position control system. Further, certain embodiments of the invention enable reduction in the number of parts in a position control apparatus, thereby facilitating its assembly. For instance, certain embodiments of the invention eliminate the need for a separate encoding element by using the conveyor belt for providing position feedback information. Additionally, certain embodiments of the invention provide a position control system that is substantially immune to undesirable effects caused by the operation of the mobile mechanism.

### BRIEF DESCRIPTION OF THE DRAWINGS

FIG. 1 is a block diagram of a prior art position control system;

FIG. 2 is a block diagram of a general-purpose, low-cost position control system according to one embodiment of the invention; and

FIGS. 3A-D are block diagrams of portions of exemplary drive belts that may be used according to embodiments of the invention.

### DETAILED DESCRIPTION OF THE INVENTION

FIG. 1 is a prior art position control system 100. More specifically, system 100 is an exemplary implementation for an ink-jet printer comprising print head 105 that is movable laterally by drive belt 110 along the X axis of FIG. 1. In this example, print head 105 is mechanically coupled to drive belt 110 via screw 135. Thus, movement of drive belt 110 imparts movement to print head 105. Print head 105 comprises optical encoder 120, which is operable to read a position indication from optical encoding strip 115 positioned parallel to drive belt 110. Optical encoder 120 is a light emitter and light sensitive transistor/photo detector assembly. Optical encoding strip 115 may be a piece of clear plastic with a set of stripes printed thereon, for example. Optical encoding strip 115 is coupled to opposing sides of the printer, and passes through optical encoder 120 mounted on print head 105. Drive belt 110 may have cogged teeth or ribs for engaging motor 125 and/or pulley 130, such that the rotational movement generated by motor 125 imparts movement to belt 110, thereby moving print head 105 laterally along the X axis of FIG. 1.

In operation, as motor 125 is activated by control system 140, drive belt 110 conveys print head 105 across optical encoding strip 115. Control systems that use position feedback (from encoder 120) to control motor 125 depending upon the position of print head 105, such as controller 140 of FIG. 1, are well known in the art and are thus not described in detail herein so as not to detract from the inventive concepts presented herein. Typically, optical encoding strip 115 contains stripes, also known as tick marks, that are printed at a resolution of 150 to 200 lines per inch. As print head 105 moves along optical encoding strip 115, optical encoder 120 measures the passage of the stripes and communicates this information to controller 140, and controller 140 determines the position of print head 105 with the resolution of the strip 115 multiplied by a quadrature factor. For example, an optical encoding strip 115 with 200 stripes per inch generally allows detection of about 1/800^{th} of an inch of print head 105 movement. However, as a person of ordinary skill in the art will recognize in light of this disclosure, embodiments of the present invention are not limited in scope to any particular resolution of detectable movement. Controller 140 uses the position information to control motor 125 (e.g., to advance print head 105 along the +/− directions of the X axis) and/or to control the ink-jets 10-13 of print head 105 (e.g., to output the appropriate mixture of color at a given position).

A problem with this prior art technology is that it is undesirably expensive. Optical encoder 120 is a precision part, and production of optical encoding strip 115 typically involves a photolithography process. Another problem with this technology is that the assembly process is overly difficult because it involves threading optical encoding strip 115 through print head 105 and then mounting encoding strip 115 securely to the printer so that it does not shift during operation. Another problem with this prior solution is that it increases the overall volume of the product. Another problem with this prior solution is that optical encoding strip 115 is subject to failure because when the drops of ink are sprayed out of the print head, an “aerosol effect” causes portions of ink to float around the system and land on the strip 115, closing the gaps necessary for detecting the position of the print head 105.

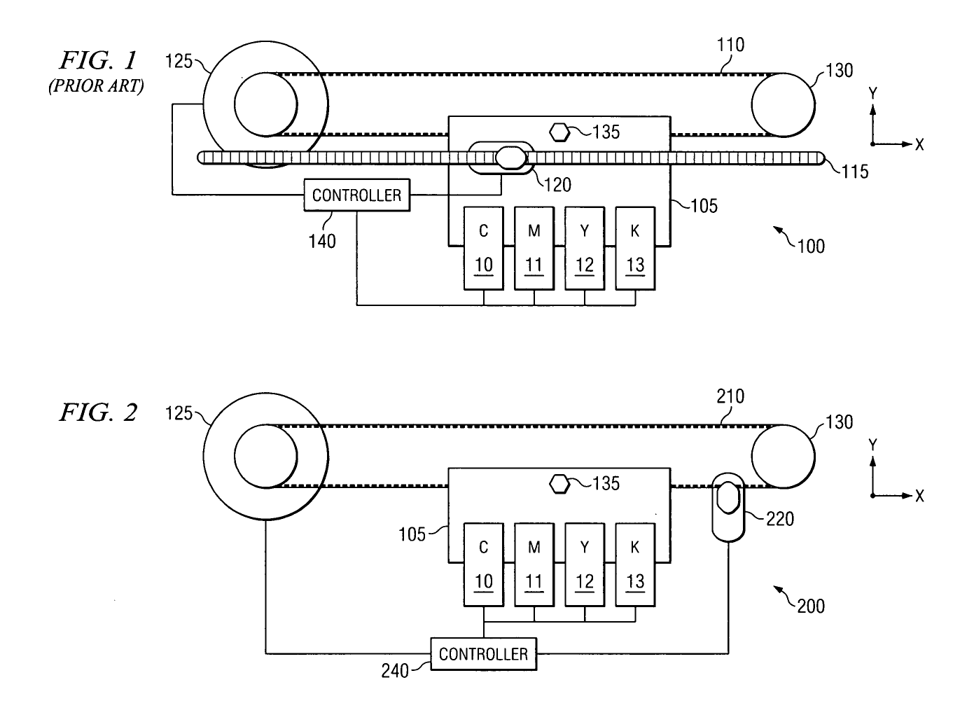

FIG. 2 is a block diagram of a general-purpose, low-cost, position control system 200, according to an exemplary embodiment of the invention. While this embodiment depicts an exemplary ink-jet printer implementation, a person of ordinary skill in the art will recognize in light of this disclosure that the present invention is not limited to this particular application, but may likewise be employed within any other device in which a movable member (e.g., print head 105) is conveyed by a conveyor mechanism (e.g., drive belt 210). For instance, this embodiment may be employed in an optical scanner or photocopier, production line conveyor belts, material handling conveyor belts, and automobile camshaft drive belts, among other applications. In this embodiment, belt 210 contains a machine-readable position encoding and is operable to convey print head 105. Various types of machine-readable position encoding techniques may be employed by belt 210. In one embodiment, belt 210 may contain slots that allow the transmission of, for example, acoustic, ultrasonic, or optical signals. In another embodiment, belt 210 comprises a pattern of teeth that reflect, for example, an acoustic, ultrasonic, or optical signal. In yet another embodiment, belt 210 comprises magnetic or metallic teeth, which can be read to detect a corresponding position of print head 105.

Also, detector assembly 220 is implemented for reading the position encoding of belt 210. Detector assembly 220 may comprise, for example, a magnetic sensor, such as a coil or the like. Alternatively, detector assembly 220 may comprise an acoustic, ultrasonic, or optical emitter and detector assembly. In one embodiment, such as that shown in FIG. 2, detector assembly 220 is fixed on the printer so that it does not move along with print head 105. In an alternative embodiment, detector assembly 220 is fixed on print head 105 and may extend to the opposing side of belt 210 in order to read the position encoding of belt 210 as print head 105 moves along the X axis of FIG. 2. As a person of ordinary skill in the art will recognize in light of this disclosure, detector assembly 220 may be positioned elsewhere, so long as it is capable of reading the position encoding implemented by belt 210.

In operation, as motor 125 is activated by control system 240, belt 210 conveys print head 105, and detector assembly 220 measures the passage of position encoding elements (e.g., slots or teeth implemented by belt 210). Information is communicated from detector assembly 220 to controller 240 indicating the detected passage of a position encoding element (e.g., slot, tooth, etc.) of belt 210. Controller 240 may keep count of how many position encoding elements have passed by, thereby keeping track of the position of print head 105. Controller 240 may then output adjustments to motor 125 according to the position of print head 105 and its desired trajectory, and/or controller 240 may communicate instructions to print head 105 to cause ink-jets 10-13 to output the appropriate mixture of colors for the corresponding position of print head 105. In one embodiment, detector assembly 220 emits an acoustic, ultrasonic, or optical signal through position encoding elements (e.g., slots) of belt 210, detects a reflection (or a transmission) from the position encoding elements, and provides an output that contains the number of position encoding elements that have passed through it. In another embodiment, detector assembly detects a magnetic field created by magnetic or metallic position encoding elements (e.g., teeth) of belt 210 as belt 210 passes through it. The output of detector assembly 220 is fed into controller 240, which determines the position of print head 105 based, at least in part, upon counting the number of detections of position encoding elements. Furthermore, controller 240 may also determine the velocity of print head 105 based, at least in part, upon the distance traveled by print head 105 as its position changes over time.

In view of the above, this exemplary embodiment alleviates the separate encoding strip 115 depicted in FIG. 1, and advantageously utilizes belt 210, not only as a conveying mechanism for conveying print head 105, but also as a position encoding mechanism that can be read (e.g., by detector 220) to determine the position of print head 105. Although the exemplary system depicted in FIG. 2 is specifically directed to ink-jet printers, a person of ordinary skill in the art will recognize in light of this disclosure that the method and apparatus for using a drive belt as a position encoder is not limited to this particular application. For example, belt 210 may be any type of drive belt for conveying any type of mechanism coupled to it, and the concepts described herein may be employed to utilize belt 210 as both a conveyor mechanism and a position encoding mechanism simultaneously.

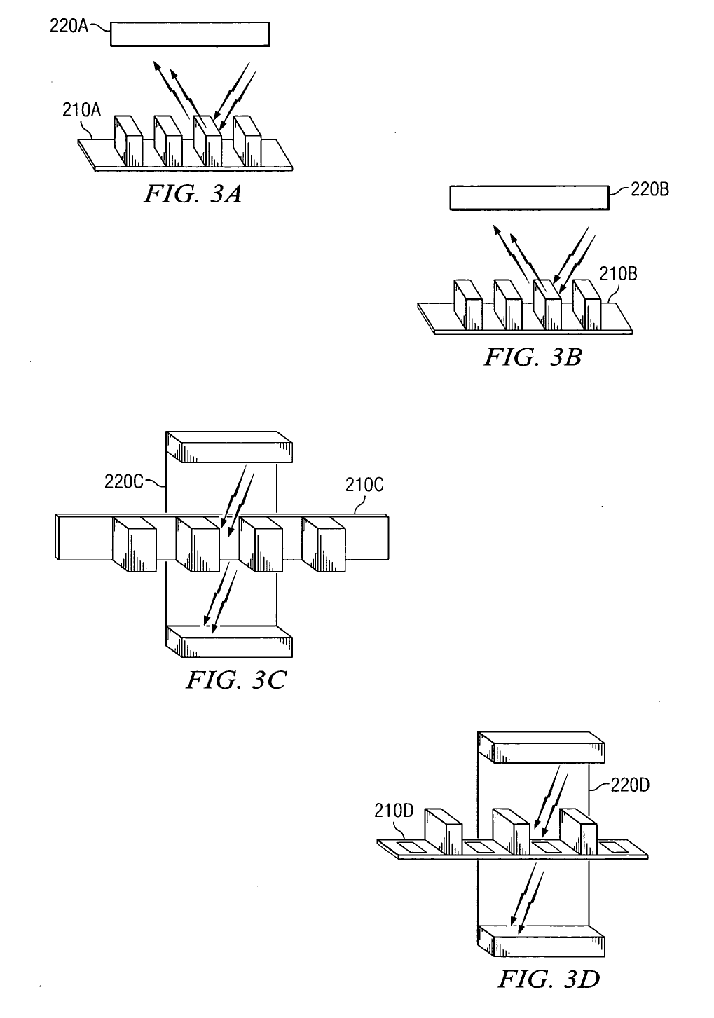

FIG. 3A is a block diagram of a portion of a drive belt 210A according to an exemplary embodiment of the invention. In this embodiment, detector assembly 220A comprises a magnetic detector. In another embodiment, detector assembly 220A may be a magnetic or electric field transducer. Alternatively, detector assembly 220A may be an ultrasonic transducer such as, for example, a piezoelectric element. In one embodiment, belt 210A may comprise magnetic position encoding elements, such as magnetic teeth and/or teeth surfaces coated with a metallic material. Belt 210A may also comprise, for example, an alternating sequence of magnetic/metallic teeth and non-magnetic/non-metallic valleys or slots. In operation, as belt 210A moves in order to convey the mechanism (e.g., print head), detector assembly 220A detects a magnetic field variation and feeds this information to control system 240, which may determine the number of position encoding elements passing through detector assembly 220A and may use this information to calculate the position of the conveyed mechanism (e.g., print head 105).

FIG. 3B is a block diagram of a portion of a drive belt 210B according to another exemplary embodiment of the invention. In this embodiment, detector assembly 220B comprises an optical emitter and detector. Belt 210B comprises optical reflective and/or absorbing position encoding elements. For example, belt 210B may be ribbed with teeth, and the valleys between the teeth may be dark (e.g., colored black) whereas the peaks of the teeth may be light (e.g., colored white). Belt 210B may comprise, for example, an alternating sequence of light and dark areas. In operation, detector assembly 220B transmits an optical signal to belt 210B, which is then reflected by the white areas (e.g., peaks) and absorbed by the black areas (e.g., valleys). As belt 210B moves in order to convey a mechanism, detector assembly 220B detects an optical reflection and feeds this information to control system 240, which may determine the number of position encoding elements passing through detector assembly 220B and may use this information to calculate the position of the conveyed mechanism (e.g., print head 105).

FIG. 3C is a block diagram of a portion of a drive belt 210C according to another exemplary embodiment of the invention. In this embodiment, detector assembly 220C may be U-shaped, comprising an optical source positioned above belt 210C and an optical sensor positioned below belt 210C. In this embodiment, belt 210C may comprise, for example, an alternating sequence of optically transmissive and optically blocking position encoding elements. For example, belt 210C comprises an alternating sequence of teeth and slots. In operation, detector assembly 220C transmits an optical signal to belt 210C, which is reflected (or otherwise blocked) by the teeth and transmitted through the slots to the optical sensor. As belt 210C moves to convey the mechanism (e.g., print head 105), detector assembly 220C detects an optical signal transmission and feeds that information to control system 240, which may determine the number of position encoding elements passing through detector assembly 220C and may use this information to calculate the position of the conveyed mechanism (e.g., print head 105).

FIG. 3D is a block diagram of a portion of a drive belt 210D according to another exemplary embodiment of the invention. In this embodiment, detector assembly 220D may be U-shaped, comprising an optical source positioned above belt 210D and an optical sensor positioned below belt 210D. In another embodiment, an acoustic or ultrasonic source is positioned above belt 210D, and an acoustic or ultrasonic sensor is positioned below belt 210D. Belt 210D may comprise an alternating pattern of teeth and slots. In operation, detector assembly 220D transmits a signal onto belt 210D, which is reflected (or otherwise blocked) by the teeth and transmitted through the slots. As belt 210D moves in order to convey the mechanism (e.g., print head 105), detector assembly 220D detects a signal transmission or reflection and feeds it to control system 240, which may determine the number of position encoding elements passing through detector assembly 220C and may use this information to calculate the position of the conveyed mechanism (e.g., print head 105).

While exemplary embodiments for implementing a position encoding mechanism by belt 210 are shown in FIGS. 3A-D, any other position encoding technique now known or later discovered may be used in accordance with embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A position control apparatus comprising:
a mechanism; and
a belt coupled to the mechanism, where the belt is operable to convey the mechanism and where the belt comprises at least one position encoding element that can be read for determining a position of the mechanism.

2. The apparatus of claim 1 further comprising a control system coupled to the belt for determining a position of the mechanism based on the at least one position encoding element.

3. The apparatus of claim 1 further comprising a magnetic sensor assembly magnetically coupled to the belt for reading the at least one position encoding element.

4. The apparatus of claim 1 further comprising an optical emitter and detector assembly optically coupled to the belt for reading the at least one position encoding element.

5. The apparatus of claim 1 further comprising an acoustic emitter and detector assembly acoustically coupled to the belt for reading the at least one position encoding element.

6. The apparatus of claim 1 where the mechanism is a print head.

7. The apparatus of claim 1 where the mechanism is one selected from the group consisting of:
head for outputting digital information on a tangible medium, and head for inputting information from a tangible medium to a digital storage device.

8. The apparatus of claim 7 where the head for outputting digital information on a tangible medium is a print head for printing said information to a document, and where the head for inputting information from a tangible medium is a scan head of an optical scanner for optically scanning information from a document to said digital storage device.

9. A belt for conveying a mechanism, the belt comprising:
a plurality of position encoding elements for providing a machine-readable encoding of a position indication of said mechanism.

10. The belt of claim 9 further comprising a sensor communicatively coupled to said belt for reading the plurality of position encoding elements.

11. The belt of claim 10 further comprising a control system communicatively coupled to said sensor, wherein said control system is operable to determine from the plurality of position encoding elements read by said sensor a corresponding position of said mechanism on said belt.

12. The belt of claim 9 further comprising at least one selected from the group consisting of: an optical emitter and detector assembly optically coupled to the belt for reading the plurality of position encoding elements; and an acoustic emitter and detector assembly acoustically coupled to the belt for reading the plurality of position encoding elements.

13. The belt of claim 9 where the position encoding elements comprise teeth, where each tooth of a subset of the teeth includes a magnetic element for encoding the position indication.

14. The belt of claim 13 further comprising:
a magnetic sensor assembly communicatively coupled to the belt for reading said magnetic element.

15. A position control method comprising:
reading a position indication from a machine-readable encoding provided by a belt conveying a mechanism; and
using the position indication to determine a position of the mechanism.

16. The method of claim 15 where reading the machine-readable position indication includes at least one selected from the group consisting of:
reading a magnetic signal, reading an optical signal, and reading an acoustic signal.

17. The method of claim 15 further comprising determining a mechanism velocity based on the position of the mechanism.

18. The method of claim 15 further comprising controlling a drive motor to move the belt based at least in part on the determined position of the mechanism.

19. A system comprising:
belt, where the belt comprises at least one position encoding element;
head attached to the belt, where the belt is operable to convey the head and the head is operable to print to a media or to scan information from the media;
sensor operable to read the at least one position encoding element; and
controller communicatively coupled to the sensor, where the controller is operable to determine a position of the head based upon the at least one position encoding element being read by said sensor.

20. The system of claim 19 further comprising:
motor coupled to the belt, where the motor is operable to move the belt to convey the head, and where the controller is communicatively coupled to the motor and operable to control the motor.
